(19) United States
(12) Patent Application Publication
(10) Pub. No.: US 2025/0329890 A1
(43) Pub. Date: Oct. 23, 2025

(54) ENERGY STORAGE DEVICE

(71) Applicant: GS Yuasa International Ltd., Kyoto-shi (JP)

(72) Inventors: Hironori AIDA, Kyoto-shi (JP); Ryoichi OKUYAMA, Kyoto-shi (JP)

(73) Assignee: GS Yuasa International Ltd., Kyoto-shi (JP)

(21) Appl. No.: 18/699,672

(22) PCT Filed: Oct. 12, 2022
(86) PCT No.: PCT/JP2022/037953

§ 371 Date: Oct. 8, 2024

(30) Foreign Application Priority Data
Oct. 13, 2021 (JP) 2021-167991

(51) Int. Cl. H01M 50/533; H01M 50/176; H01M 50/188; H01M 50/553

(52) U.S. Cl. CPC H01M 50/533; H01M 50/176; H01M 50/188; H01M 50/553

(57) ABSTRACT

An energy storage device includes: an electrode assembly that is formed by stacking a plurality of plates and is elongated in a predetermined direction intersecting with a stacking direction; a container that accommodates the electrode assembly; and a terminal that is electrically connected to the electrode assembly. The electrode assembly includes: an electrode assembly body; and a connecting portion that protrudes from an end portion of the electrode assembly body in a predetermined direction. The terminal includes a terminal body portion that protrudes from a terminal mounting surface of the container in a direction intersecting with the stacking direction. A distal end portion of the electrode assembly body in a protruding direction of the terminal body portion protrudes with respect to the terminal mounting surface.

### TECHNICAL FIELD

The present invention relates to an energy storage device that includes an electrode assembly.

### BACKGROUND ART

Conventionally, there has been known an energy storage device in which a pair of terminals (a negative electrode output terminal and a positive electrode terminal) is mounted on a lid body (lid) of a container which accommodates an electrode assembly in a state where the pair of terminals protrudes (see, for example, Patent Document 1).

### PRIOR ART DOCUMENT

### Patent Document

Patent Document 1: JP-A-2010-73580

### SUMMARY OF THE INVENTION

### Problems to be Solved by the Invention

In recent years, an energy storage device is required to be capable of storing a larger electrode assembly by using a container that has a longer length between terminals. In such an energy storage device, a pair of terminals protrudes from a lid body. As a result, in a case where a pair of terminals protrude from a lid body so that a distance between the terminals of the container is elongated, a surplus space formed between the terminals outside the container also becomes large. In order to suppress the surplus space outside the container from becoming large, it may be considered that the energy storage device adopts a configuration where a recessed portion for accommodating terminals is formed on the container. However, in a case where a surplus space is formed in the container attributed to such a recessed portion, as a result, there is a concern that space utilization efficiency of the energy storage device is reduced.

It is an object of the present invention to suppress the lowering of space utilization efficiency of an energy storage device.

### Means for Solving the Problems

To achieve the above-mentioned object, according to one aspect of the present invention, there is provided an energy storage device that includes: an electrode assembly that is formed by stacking a plurality of plates and is elongated in a predetermined direction intersecting with a stacking direction; a container that accommodates the electrode assembly; and a terminal that is electrically connected to the electrode assembly, in which the electrode assembly includes: an electrode assembly body; and a connecting portion that protrudes from an end portion of the electrode assembly body in the predetermined direction, the terminal includes a terminal body portion that protrudes from a terminal mounting surface of the container in a direction intersecting with the stacking direction, and a distal end portion of the electrode assembly body in a protruding direction of the terminal body portion protrudes with respect to the terminal mounting surface.

### Advantages of the Invention

According to the present invention, it is possible to suppress the lowering of the space utilization efficiency of an energy storage device.

### BRIEF DESCRIPTION OF THE DRAWINGS

FIG. 1 is a perspective view illustrating an external appearance of an energy storage device according to an embodiment.

FIG. 2 is an exploded perspective view of the energy storage device according to the embodiment illustrating respective constituent elements in a state where the energy storage apparatus is disassembled.

FIG. 3 is a perspective view illustrating the configuration of an electrode assembly according to the embodiment.

FIG. 4 is a plan view illustrating a first side surface portion according to the embodiment.

FIG. 5 is a plan view schematically illustrating an energy storage device according to a comparative example.

FIG. 6 is a plan view illustrating a first side surface portion according a modification 1 of the embodiment.

FIG. 7 is a plan view illustrating a first side surface portion according a modification 2 of the embodiment.

FIG. 8 is a top plan view illustrating a first side surface portion according to a modification 3 of the embodiment.

FIG. 9 is an explanatory view illustrating rough positions of the first side surface portion, a second side surface portion, and recessed portions according to the embodiment.

### MODE FOR CARRYING OUT THE INVENTION

(1) According to one aspect of the present invention, there is provided an energy storage device that includes: an electrode assembly that is formed by stacking a plurality of plates and is elongated in a predetermined direction intersecting with a stacking direction; a container that accommodates the electrode assembly; and a terminal that is electrically connected to the electrode assembly, in which the electrode assembly includes: an electrode assembly body; and a connecting portion that protrudes from an end portion of the electrode assembly body in the predetermined direction, the terminal includes a terminal body portion that protrudes from a terminal mounting surface of the container in a direction intersecting with the stacking direction, and a distal end portion of the electrode assembly body in a protruding direction of the terminal body portion protrudes with respect to the terminal mounting surface.

According to the energy storage device of one aspect of the present invention, the distal end portion of the terminal body portion of the electrode assembly body in a protruding direction protrudes with respect to the terminal mounting surface of the container and hence, the electrode assembly body can be disposed in the surplus space formed between the terminal body portions of the pair of terminals. With such a configuration, the surplus space in the container can be reduced. Accordingly, it is possible to suppress the lowering of the space utilization efficiency of the energy storage device.
(2) In the energy storage device described in the above-mentioned (1), the distal end portion of the electrode assembly body may protrude more than a distal end portion of the terminal body portion.

According to the energy storage device described in the above-mentioned (2), the distal end portion of the electrode assembly body protrudes more than the distal end portions of the terminal body portions. Accordingly, the electrode assembly body can be disposed with a larger size in the surplus space formed between the terminal body portions of the pair of terminals. Accordingly, it is possible to suppress the lowering of the space utilization efficiency of the energy storage device.
(3) The energy storage device described in the above-mentioned (1) or (2) may further include a current collector that is accommodated in the container and electrically connects the connecting portion and the terminal, and the current collector may extend in a direction intersecting with a protruding direction of the connecting portion in a space that overlaps with the terminal mounting surface when the terminal mounting surface is viewed in a plan view.

According to the energy storage device described in (3), the current collector extends in the direction intersecting with the protruding direction of the connecting portion in the space that overlaps with the terminal mounting surface and hence, the current collector does not protrude from the space. That is, the current collector and the connecting portion are joined in the space and hence, the joining structure of these constitutional elements does not protrude from the space. With such a configuration, the electrode assembly body can be disposed as large as possible and hence, an electric capacitance can be further increased.
(4) The energy storage device described in the above-mentioned (1) or (2) may further include a current collector that is accommodated in the container and electrically connects the connecting portion and the terminal, the current collector may include a first joint portion that is joined to the connecting portion and a second joint portion that is joined to the terminal, and the second joint portion may be bent in a direction away from the electrode assembly body with respect to the first joint portion.

According to the energy storage device described in the above-mentioned (4), the second joint portion is bent with respect to the first joint portion in a direction away from the electrode assembly body and hence, the second joint portion can be easily joined to the terminal disposed more outside than the electrode assembly body.
(5) In the energy storage device according to any one of the above-mentioned (1) to (4), a length of the terminal body portion in the stacking direction may be longer than a length of the terminal body portion in the predetermined direction.

In the energy storage device described in the above (5), the length of the terminal body portion in the stacking direction is longer than the length of the terminal body portion in the predetermined direction. Accordingly, it is possible to form the terminal body portion as large as possible in the terminal mounting surface while suppressing the increase in size of the container in the predetermined direction. With such a configuration, a joint area between the conductive member such as a bus bar and the terminal body portion can be made as large as possible.
(6) In the energy storage device described in any one of the above-mentioned (1) to (5), the connecting portion may be disposed in a space that overlaps with the terminal mounting surface when the terminal mounting surface is viewed in a plan view.

According to the energy storage device described in the above-mentioned (6), the connecting portion is disposed in the space that overlaps with the terminal mounting surface when the terminal mounting surface is viewed in the plan view and hence, the electrode assembly body can be formed as large as possible. The electrode assembly body is a portion that contributes to the storage of energy (the generation of power) and hence, if the portion can be formed with a large size, the electric capacitance can be increased.

To achieve the above-mentioned object, according to another aspect of the present invention, there is provided an energy storage device that includes: an electrode assembly that is formed by stacking a plurality of plates and is elongated in a predetermined direction intersecting with a stacking direction; a container that accommodates the electrode assembly; and a pair of terminals that is electrically connected to the electrode assembly, in which the electrode assembly includes: an electrode assembly body; and a pair of connecting portions that protrudes from both end portions of the electrode assembly body in the predetermined direction, the pair of terminals is disposed at positions where the pair of terminals interpose the electrode assembly body in the predetermined direction, at least one terminal out of the pair of terminals includes a terminal body portion that protrudes from a terminal mounting surface in the container in a direction intersecting with the stacking direction, and a distal end portion of the electrode assembly body in a protruding direction of the terminal body portion is coplanar with the terminal mounting surface or protrudes with respect to the terminal mounting surface.

According to the energy storage device of another aspect of the present invention, the distal end portion of the terminal body portion of the electrode assembly body in the protruding direction is coplanar with the terminal mounting surface of the container or protrudes with respect to the terminal mounting surface of the container. Accordingly, the electrode assembly body can be disposed in the surplus space formed between the terminal body portions of the pair of terminals. With such a configuration, the surplus space in the container can be reduced. Accordingly, it is possible to suppress the lowering of the space utilization efficiency of the energy storage device.

### Embodiments

Hereinafter, energy storage devices according to the embodiments (including modifications of the embodiments) of the present invention are described with reference to the drawings. All embodiments described hereinafter are comprehensive examples or specific examples. Numerical values, shapes, materials, constitutional elements, arrangement positions and connection modes of the constitutional elements, manufacturing steps, the order of the manufacturing steps, and the like in the following exemplary embodiment are provided as examples, and are not intended to limit the present invention. In the respective drawings, sizes and the like are not strictly illustrated. In the respective drawings, identical or substantially identical constitutional elements are given the same symbols.

In the following description and drawings, a direction extending along a winding axis of an electrode assembly, a direction along which the electrode assembly extends, or a direction that a pair of short-side surfaces of a container faces each other is defined as an X-axis direction. A direction along which a pair of long-side surfaces of the container faces each other or a thickness direction of the container is defined as a Y-axis direction. A direction along which a bottom surface of a container body of the container and a top surface of a lid body are arranged or a vertical direction is defined as a Z-axis direction. The X-axis direction is an example of a predetermined direction. These X-axis direction, Y-axis direction, and Z-axis direction are the directions that intersect with each other (orthogonal to each other in the present embodiments). A configuration is also considered where the Z-axis direction is not the vertical direction depending on a use mode. However, in the description made hereinafter, for the sake of convenience of the description, the description is made by assuming the Z-axis direction as the vertical direction.

In the description made hereinafter, an X-axis positive direction indicates an arrow direction of an X-axis, and an X-axis negative direction indicates a direction opposite to the X-axis positive direction. The same goes for the Y-axis direction and the Z-axis direction. Expressions indicating the relative directions or the relative postures such as “parallel” or “orthogonal” also include cases where such directions or postures are not taken in a strict meaning of the terms. For example, a state where two directions are orthogonal to each other means not only a state where these two directions are completely orthogonal to each other but also a state where these two directions are substantially orthogonal to each other, that is, for example, a state where these two directions are orthogonal to each other with slight deviation of approximately several percent.

### 1 Description of Overall Configuration of Energy Storage Device

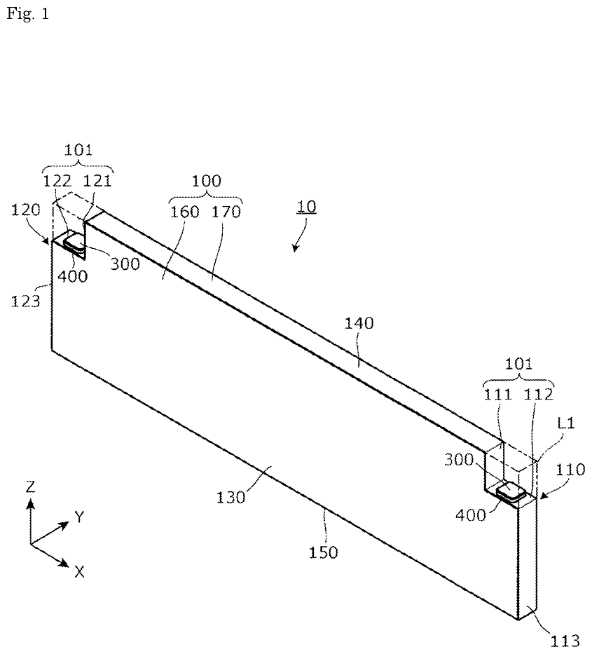

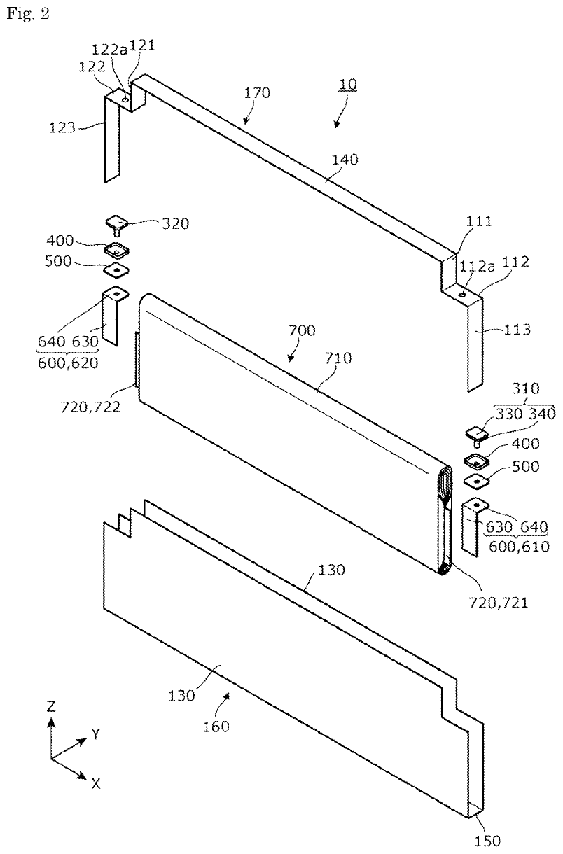

First, the overall configuration of an energy storage device 10 according to the embodiment will be described with reference to FIG. 1 and FIG. 2. FIG. 1 is a perspective view illustrating an external appearance of the energy storage device 10 according to the embodiment. FIG. 2 is an exploded perspective view of the energy storage device 10 according to the embodiment illustrating respective constitutional elements when the energy storage device 10 is disassembled.

The energy storage device 10 is an energy storage device into which electricity can be charged from the outside and from which electricity can be discharged to the outside. In this embodiment, the energy storage device 10 has an approximately rectangular parallelepiped shape. For example, the energy storage device 10 is a battery used in an electricity storage application, a power source application, or the like. Specifically, the energy storage device 10 is used as a battery or the like for driving a mobile body such as an automobile, a motorcycle, a watercraft, a ship, a snowmobile, an agriculture machine, a construction machine, or a railway vehicle for an electric railway, or is used as a battery for starting an engine of the mobile body. As the above-described automobile, an electric vehicle (EV), a hybrid electric vehicle (HEV), a plug-in hybrid electric vehicle (PHEV), and an automobile that uses a fossils fuel (a gasoline, a light oil, a liquefied natural gas or the like) are exemplified. As an example of the railway vehicle for the electric railway described above, a train, a monorail, a linear motor car, and a hybrid train including both a diesel engine and an electric motor are exemplified. The energy storage device 10 can also be used as a stationary battery or the like used as a home-use battery, a business-use battery, or the like.

The energy storage device 10 is not limited to a non-aqueous electrolyte secondary battery. The energy storage device 10 may be a secondary battery other than the non-aqueous electrolyte secondary battery, or may be a capacitor. The energy storage device 10 is not necessarily a secondary battery, and may be a primary battery that allows a user to use stored electricity even when the user does not charge the energy storage device 10. The energy storage device 10 may be a battery that uses a solid electrolyte. The energy storage device 10 may be a pouch-type energy storage device. In the present embodiment, the energy storage device 10 that uses a flat rectangular parallelepiped shape as the reference is illustrated. However, the shape of the energy storage device 10, that is, the shape of the container 100 is not limited to a shape that is formed using a rectangular parallelepiped shape as the reference, and may be a shape that is formed using a polygonal columnar shape, an elongated circular columnar shape, an elliptical columnar shape, a circular columnar shape or the like other than the rectangular parallelepiped shape as the reference.

As illustrated in FIG. 1 and FIG. 2, the energy storage device 10 includes: a container 100; a pair of electrode terminals 300, and a pair of outer gaskets 400. A pair of inner gaskets 500, a pair of current collectors 600, and an electrode assembly 700 are accommodated in the container 100. Specifically, respective members (the electrode terminal 300, the outer gasket 400, an inner gasket 500, a current collector 600 and the like, the same understanding being adopted in the description made hereinafter) of a positive electrode are disposed on one end portion of the container 100 in the X-axis positive direction. The respective members of a negative electrode are disposed at the other end portion of the container 100 in the X-axis negative direction. To be further more specific, on a first side surface portion 110 of the container 100 in the X-axis positive direction, the respective members of the positive electrode are disposed at an end portion in the Z-axis positive direction. That is, the first side surface portion 110 is a range where the respective members of the positive electrode are disposed from an end surface of the container 100 in the X-axis positive direction. For example, the first side surface portion 110 is a portion within a range of 1% to 10% of the length of the container 100 from the end surface of the container 100 in the X-axis positive direction with respect to the X-axis direction.

On a second side surface portion 120 of the container 100 in the X-axis negative direction, the respective members of the negative electrode are disposed at an end portion in the Z-axis positive direction. That is, the second side surface portion 120 is a range in which the respective members of the negative electrode are disposed from an end surface of the container 100 in the X-axis negative direction. For example, the second side surface portion 120 is a portion within a range of 1% to 10% of the length of the container 100 from the end surface of the container 100 in the X-axis negative direction with respect to the X-axis direction.

Although an electrolytic solution (a non-aqueous electrolyte) is sealed in the container 100, the illustration of the electrolytic solution is omitted. A kind of the electrolyte solution is not particularly limited provided that the performance of the energy storage device 10 is not impaired, and various kinds of electrolyte solutions can be selected. Besides the constituent elements described above, the energy storage device 10 may further include: spacers that are disposed on the sides of the electrode assembly 700, above the electrode assembly 700, or below the electrode assembly 700; an insulating film that wraps the electrode assembly 700; and the like.

The container 100 is a case having a profile (a substantially rectangular parallelepiped shape) using a flat rectangular parallelepiped shape that is elongated in the X-axis direction as the reference. For example, a length of the container 100 in the X-axis direction is set 3 times or more as long as a length of the container 100 in the Z-axis direction. In FIG. 1, the rectangular parallelepiped shape that is used as the reference is indicated by a double-dashed chain line L1. Specifically, the container 100 has the profile where a cutout having a rectangular shape is formed at upper portions of both end portions in the X-axis direction of the flat rectangular parallelepiped shape elongated in the X-axis direction. It may be also expressed that each cutout forms a recessed portion 101 as viewed in view of the rectangular parallelepiped shape used as the reference. That is, the recessed portion 101 is formed on each of the first side surface portion 110 and the second side surface portion 120 of the container 100 at the end portion in the Z-axis positive direction. Further, the electrode terminal 300 is disposed in the recessed portion 101. With such a configuration, in each of the first side surface portion 110 and the second side surface portion 120 of the container 100, the recessed portion 101 and (the entirety of) the electrode terminal 300 in the recessed portion 101 overlap with each other in the Z-axis direction.

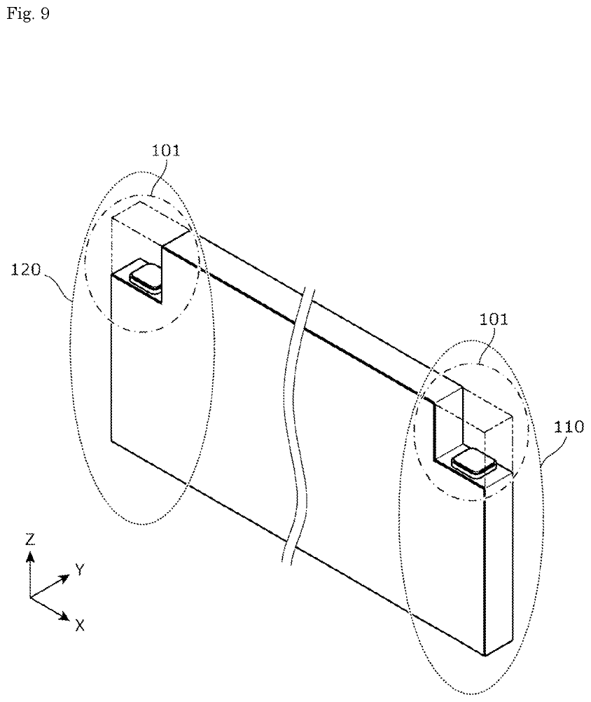

FIG. 9 is an explanatory view illustrating rough positions of the first side surface portion 110, a second side surface portion 120, and the recessed portions 101 according to the embodiment. In FIG. 9, the first side surface portion 110 and the second side surface portion 120 are surrounded by a broken line, and the recessed portions 101 are surrounded by a dotted chain line.

As illustrated in FIG. 1 and FIG. 2, specifically, the first side surface portion 110 includes a first upper side surface 111, a first upper surface 112, and a first side surface 113. The first side surface portion 110 is elongated in the Z-axis direction as viewed in the X-axis direction. The first upper side surface 111 is disposed at an upper portion of the first side surface portion 110, and is a rectangular flat surface that is parallel to a YZ plane and is elongated in the Z-axis direction. The first upper surface 112 is a flat surface extending in the X-axis positive direction from a lower end of the first upper side surface 111, and is a rectangular flat surface that is parallel to the XY plane and is elongated in the X-axis direction. The first side surface 113 is a flat surface extending downward from an end portion of the first upper surface 112 in the X-axis positive direction, and is a rectangular flat surface that is parallel to the YZ plane and is elongated in the Z-axis direction. In this manner, the recessed portion 101 of the first side surface portion 110 is defined by the first upper side surface 111 and the first upper surface 112, and an end portion of the recessed portion 101 in the Z-axis positive direction and an end portion of the recessed portion 101 in the X-axis positive direction are opened. Accordingly, the end portion of the first side surface portion 110 in the Z-axis positive direction (a corner portion of the container 100 in the X-axis positive direction and in the Z-axis positive direction) is formed in a shape where surfaces extending in the X-axis direction and the Z-axis direction are recessed and the shape penetrates in the Y-axis direction. In other words, the recessed portion 101 of the first side surface portion 110 is a recessed portion where a corner portion of the container 100 in the X-axis positive direction and in the Z-axis positive direction is recessed (cutted out) in a quadrangular shape (L shape) as viewed in the Y-axis direction.

The second side surface portion 120 includes a second upper side surface 121, a second upper surface 122, and a second side surface 123. The second side surface portion 120 is elongated in the Z-axis direction as viewed in the X-axis direction. The second upper side surface 121 is disposed at an upper portion of the second side surface portion 120, and the second upper side surface 121 is a rectangular flat surface that is parallel to the YZ plane and is elongated in the Z-axis direction. The second upper surface 122 is a flat surface extending in the X-axis negative direction from a lower end of the second upper side surface 121, and the second upper surface 122 is a rectangular flat surface that is parallel to the XY plane and is elongated in the X-axis direction. The second side surface 123 is a flat surface extending downward from an end portion of the second upper surface 122 in the X-axis negative direction, and the second side surface 123 is a rectangular flat surface that is parallel to the YZ plane and is elongated in the Z-axis direction. In this manner, the recessed portion 101 of the second side surface portion 120 is defined by the second upper side surface 121 and the second upper surface 122, and an end portion of the recessed portion 101 in the Z-axis positive direction and an end portion of the recessed portion 101 in the X-axis negative direction are opened. Accordingly, the end portion of the second side surface portion 120 in the Z-axis positive direction (a corner portion of the container 100 in the X-axis negative direction and in the Z-axis positive direction) is formed in a shape where surfaces extending in the X-axis direction and the Z-axis direction are recessed and the shape penetrates in the Y-axis direction. In other words, the recessed portion 101 of the second side surface portion 120 is a recessed portion where a corner portion of the container 100 in the X-axis negative direction and in the Z-axis positive direction is recessed (cutted out) in a quadrangular shape (L shape) as viewed in the Y-axis direction.

In the container 100, both end surfaces that face each other in the Y-axis direction each form the long side surfaces 130. Each long side surface 130 is a flat surface that is parallel to the XZ plane and is elongated in the X-axis direction, and both end portions of the long side surface 130 in the X-axis direction have shapes corresponding to the first side surface portion 110 and the second side surface portion 120.

With respect to both end surfaces of the container 100 that face each other in the Z-axis direction, the end surface in the Z-axis positive direction is a top surface 140, and the end surface in the Z-axis negative direction is a bottom surface 150. The top surface 140 is a rectangular flat surface that is parallel to the XY plane and is elongated in the X-axis direction. The top surface 140 connects an upper end of the first upper side surface 111 of the first side surface portion 110 and an upper end of the second upper side surface 121 of the second side surface portion 120. The bottom surface 150 is a rectangular flat surface that is parallel to the XY plane and is elongated in the X-axis direction. The bottom surface 150 connects the lower end of the first side surface 113 of the first side surface portion 110 and the lower end of the second side surface 123 of the second side surface portion 120.

The container 100 includes a container body 160 and a lid body 170, and is formed in a substantially rectangular parallelepiped shape by assembling the container body 160 and the lid body 170. The container body 160 has a pair of long side surfaces 130 and the bottom surface 150. The lid body 170 has the first upper side surface 111, the first upper surface 112, the first side surface 113, the second upper side surface 121, the second upper surface 122, the second side surface 123, and the top surface 140.

Specifically, the container body 160 is a substantially U-shaped sheet metal with an upper side thereof opened as viewed in the X-axis direction. The container body 160 has flat plate-shaped long side wall portions that form a pair of the long side surfaces 130 at both end portions thereof in the Y-axis direction. The container body 160 has a flat plate-shaped rectangular bottom wall portion that forms the bottom surface 150 at an end portion in the Z-axis negative direction.

The lid body 170 is a sheet metal with a lower side thereof opened as viewed in the Y-axis direction. The lid body 170 has a bent plate portion that forms the first upper side surface 111, the first upper surface 112, and the first side surface 113 at an end portion in the X-axis positive direction. The lid body 170 has a bent plate portion that forms the second upper side surface 121, the second upper surface 122, and the second side surface 123 at an end portion in the X-axis negative direction. The lid body 170 has a flat plate-shaped and rectangular top wall portion that forms the top surface 140 at an end portion in the Z-axis positive direction.

With such a configuration, the container 100 has the structure where the inside of the container 100 is sealed. Such sealed structure is obtained by housing the electrode assembly 700 and the like in the container body 160 and, thereafter, by joining the container body 160 and the lid body 170 to each other by welding or the like. A material of the container 100 (the container body 160 and the lid body 170) is not particularly limited. However, for example, it is preferable that the container 100 be made of weldable metal such as stainless steel, aluminum, an aluminum alloy, iron, or a plated steel plate.

Although not illustrated in the drawings in this embodiment, a solution filling portion and a gas release valve are formed on the lid body 170. The gas release valve is a safety valve that releases a pressure in the container 100 when such a pressure is excessively increased. The solution filling portion is a portion for filling an electrolyte solution into the container 100 at the time of manufacturing the energy storage device 10.

The electrode terminals 300 are terminals (a positive electrode terminal 310 and a negative electrode terminal 320) that are electrically connected to the electrode assembly 700 via the current collectors 600. That is, the electrode terminals 300 are members that are made of metal and are provided for discharging electricity stored in the electrode assembly 700 to a space outside the energy storage device 10, and for charging electricity into an inner space in the energy storage device 10 to store electricity in the electrode assembly 700. Although a material of the electrode terminal 300 is not particularly limited, for example, the electrode terminals 300 (the positive electrode terminal 310 and the negative electrode terminal 320) are respectively formed of a conductive member made of aluminum, an aluminum alloy, copper, a copper alloy or the like. The electrode terminals 300 are connected (joined) to the current collectors 600 by caulking, welding or the like, and are mounted on the lid body 170.

In the present embodiment, the electrode terminal 300 includes a terminal body portion 330 and a shaft portion 340 that protrudes from the terminal body portion 330. The electrode terminal 300 may be a bolt terminal having a bolt portion that protrudes in the Z-axis direction and on which a male screw portion is formed. The terminal body portion 330 is a portion that protrudes outward from a terminal mounting surface of the container 100. The terminal mounting surface is formed of the first upper surface 112 or the second upper surface 122. At any terminal mounting surface, the terminal body portion 330 protrudes outward from the container 100 along the Z-axis direction. Through holes 112a, 122a through which a shaft portion 340 passes are formed in the lid body 170 at positions that correspond to the respective terminal mounting surfaces. The shaft portion 340 is connected (joined) to the current collector 600 by caulking in a state where the shaft portion 340 penetrates the terminal mounting surface, the outer gasket 400, the inner gasket 500 and the current collector 600. The positional relationship between the terminal body portions 330 and the respective recessed portions 101 after joining will be described later.

The current collectors 600 are current collecting members (a positive electrode current collector 610 and a negative electrode current collector 620) having conductivity. The current collectors 600 are provided such that one current collector 600 is disposed on each of both sides of the electrode assembly 700 in the X-axis direction. The current collectors 600 are connected (joined) to the electrode assembly 700 and the electrode terminals 300 so as to electrically connect the electrode assembly 700 and the electrode terminals 300 to each other. Specifically, the current collector 600 is an integral body formed of: a first joint portion 630 that is connected (joined) to a connecting portion 720 of the electrode assembly 700 described later by welding, caulking or the like; and a second joint portion 640 that is connected (joined) to the electrode terminal 300 by caulking, welding or the like and is connected to the lid body 170 as described above. The first joint portion 630 and the second joint portion 640 are each a flat plate-like portion. The first joint portion 630 and the second joint portion 640 are formed by bending one sheet metal. The details of the current collector 600 will be described later.

Although a material of the current collector 600 is not particularly limited, for example, the positive electrode current collector 610 is formed of a conductive member made of aluminum or an aluminum alloy or the like in the same manner as a positive electrode substrate 741 of the electrode assembly 700 described later, and the negative electrode current collector 620 is formed of a conductive member made of copper or a copper alloy or the like in the same manner as a negative electrode substrate 751 of the electrode assembly 700 described later.

The outer gasket 400 is a plate-like rectangular sealing member having insulating property that is disposed between the lid body 170 of the container 100 and the electrode terminal 300. The outer gasket 400 provides insulation and sealing between the lid body 170 and the electrode terminal 300. The inner gasket 500 is a plate-like rectangular sealing member having insulating property that is disposed between the lid body 170 and the current collector 600. The inner gasket 500 provides insulation and sealing between the lid body 170 and the current collector 600. The outer gasket 400 and the inner gasket 500 are made of a resin or the like having an electrically insulating material such as polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene/perfluoroalkyl vinyl ether (PFA), polytetrafluoroethylene (PTFE), polyether sulfone (PES), an ABS resin, or a composite material of the above-described materials.

The electrode assembly 700 is an energy storage element (a power generating element) that is formed by winding plates and can store electricity. The electrode assembly 700 has an elongated shape extending in the X-axis direction, and has an elongated circular shape as viewed in the X-axis direction. The electrode assembly 700 has a shape where a length in the X-axis direction is, for example, 300 mm or more, and more specifically, about 500 mm to 1500 mm. With such a configuration, the length of the electrode assembly 700 in the X-axis direction is set longer than the length of the electrode assembly 700 in the Z-axis direction. For example, the length of the electrode assembly 700 in the X-axis direction is 3 times or more as large as the length of the electrode assembly 700 in the Z-axis direction. The electrode assembly 700 includes: a body portion (electrode assembly body) 710; and a pair of connecting portions 720 that protrudes from both end portions of the body portion 710. As described above, the connecting portions 720 are connected (joined) to the current collectors 600.

Specifically, the plurality of connecting portions 720 protrude from an intermediate portion in the Z-axis direction at both end portions of the body portion 710 in the X-axis direction. For example, a positive electrode connecting portion 721 is disposed at the intermediate portion in the Z-axis direction at one end surface of the body portion 710 in the X-axis positive direction, and the negative electrode connecting portion 722 is disposed at the intermediate portion in the Z-axis direction at the other end surface of the body portion 710 in the X-axis negative direction. The configuration of such an electrode assembly 700 will be described in detail hereinafter.

### 2 Description of Configuration of Electrode Assembly 700

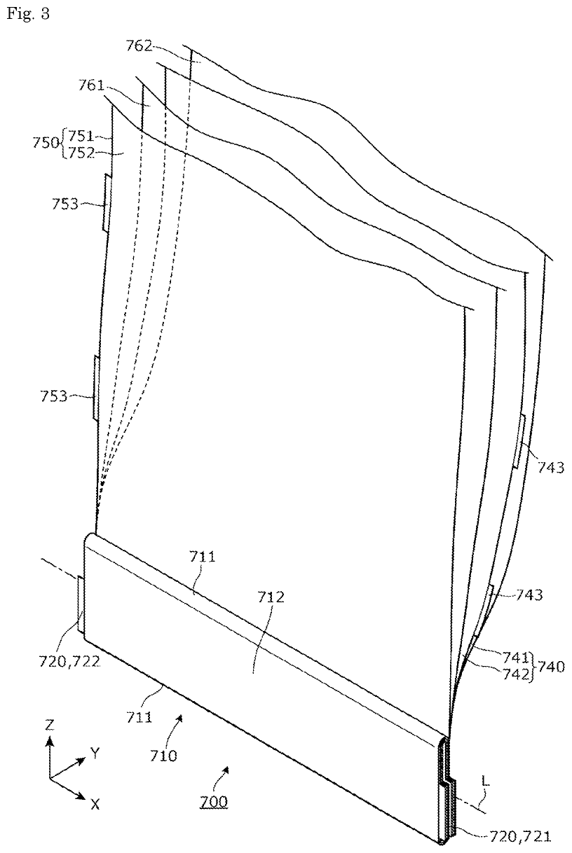

FIG. 3 is a perspective view illustrating the configuration of the electrode assembly 700 according to the embodiment. Specifically, FIG. 3 illustrates the configuration of the winding state of the plates in the electrode assembly 700 in a state where the winding state of the plates is partially developed. As illustrated in FIG. 3, the electrode assembly 700 includes a positive plate 740, a negative plate 750, and separators 761, 762.

The positive plate 740 is a plate (an electrode plate) that is formed such that a positive active material layer 742 is formed on a surface of the positive electrode substrate 741 that is an elongated strip-shaped metal foil made of aluminum or an aluminum alloy. The negative plate 750 is a plate (an electrode plate) that is formed such that a negative active material layer 752 is formed on a surface of the negative electrode substrate 751 that is an elongated strip-shaped metal foil made of copper or a copper alloy. As materials for forming the positive electrode substrate 741 and the negative electrode substrate 751, known materials such as nickel, iron, stainless steel, titanium, fired carbon, a conductive polymer, a conductive glass, and an Al—Cd alloy can be appropriately used provided that the materials are stable to an oxidation-reduction reaction during charging and discharging. As a positive active material used for forming the positive active material layer 742 and a negative active material used for forming the negative active material layer 752, known materials can be appropriately used provided that the materials are a positive active material and a negative active material capable of occluding and discharging lithium ions.

For example, as the positive active material, a polyanion compound such as LiMPO₄, LiMSiO₄, or LiMBO₃ (M representing one kind or two or more kinds of transition metal elements selected from Fe, Ni, Mn, Co, and the like), lithium titanate, a spinel-type lithium manganese oxide such as LiMn₂O₄ or LiMm_{1.5}Ni_{0.5}O₄, a lithium transition metal oxide such as LiMO₂ (M representing one kind or two or more kinds of transition metal elements selected from Fe, Ni, Mn, Co, and the like), or the like can be used. As the negative active material, besides lithium metal and a lithium alloy (lithium metal-containing alloys such as lithium-silicon, lithium-aluminum, lithium-lead, lithium-tin, lithium-aluminum-tin, lithium-gallium, and a wood's alloy), an alloy capable of occluding and releasing lithium, a carbon material (for example, graphite, non-graphitizable carbon, graphitizable carbon, low-temperature calcined carbon, amorphous carbon, and the like), a silicon oxide, a metal oxide, a lithium metal oxide (Li₄Ti₅O₁₂ or the like), a polyphosphoric acid compound, and a compound of transition metal and an element belong to any one of groups 14 to 16, such as Co₃O₄ or Fe₂P, that is generally referred to as a conversion negative electrode can be named.

The separators 761, 762 are each formed of a microporous sheet made of a resin. As a material of the separators 761 and 762, a known material can be appropriately used provided that the performance of the energy storage device 10 is not impaired. For example, as the separators 761 and 762, a woven fabric that is insoluble in an organic solvent, a nonwoven fabric, a synthetic resin microporous membrane made of a polyolefin resin such as polyethylene, or the like can be used.

The electrode assembly 700 is formed by alternately stacking and winding the positive plate 740, the negative plate 750, and the separators 761, 762. That is, the electrode assembly 700 is formed by stacking and winding the negative plate 750, the separator 761, the positive plate 740, and the separator 762 in this order. In the present embodiment, the electrode assembly 700 is a winding-type electrode assembly formed by winding the positive plate 740, the negative plate 750 and the like around the winding axis L extending in the X-axis direction. The winding axis L is a virtual axis that becomes a central axis when the positive plate 740, the negative plate 750 and the like are wound, and in the present embodiment, the winding axis L is a straight line which passes through the center of the electrode assembly 700 and is parallel to the X-axis direction.

On the one end edge (end edge in the X-axis positive direction) of the positive plate 740 in the winding axis direction, a plurality of protruding members 743 that protrude outward are disposed at a predetermined interval. In the same manner, on the other end edge (end edge in the X-axis negative direction) of the negative plate 750 in the winding axis direction, a plurality of protruding members 753 that respectively protrude outward are disposed at a predetermined interval. Each of the protruding members 743 and 753 is a portion where the active material layer containing the active material is not formed and the substrate layer is exposed (an active material layer-non-formed portion).

When the positive plate 740, the negative plate 750, and the separators 761 and 762 are wound, the protruding members 743 of the positive plate 740 overlap with each other on one end surface of the body portion 710, and the protruding members 753 of the negative plate 750 overlap with each other on the other end surface of the body portion 710. A portion where the protruding members 743 of the positive plate 740 overlap with each other forms the positive electrode connecting portion 721. That is, the positive electrode connecting portion 721 is a portion that is formed by stacking a plurality of one members (protruding members 743) of the plate having the same polarity (the positive plates 740) out of the plurality of plates (the positive plate 740 and the negative plate 750).

In the same manner, a portion where the respective protruding members 753 of the negative plate 750 overlap with each other forms the negative electrode connecting portion 722. That is, the negative electrode connecting portion 722 is a portion formed by stacking a plurality of one members (protruding members 753) of the plate (the negative plate 750) having the same polarity out of the plurality of plates (the positive plate 740 and the negative plate 750).

In this manner, the electrode assembly 700 includes: the body portion 710 that forms the body of the electrode assembly 700; and the plurality of connecting portions 720 (the positive electrode connecting portion 721 and the negative electrode connecting portion 722) that respectively protrude from both end surfaces of the body portion 710 in the X-axis direction.

The body portion 710 is an elongated circular columnar portion (an active material layer forming portion) formed by winding portions of the positive plate 740 and the negative plate 750 where the positive active material layer 742 and the negative active material layer 752 are formed (coated) and the separators 761 and 762. With such a configuration, the body portion 710 has a pair of curved portions 711 on both sides in the Z-axis direction, and the body portion 710 has a flat portion 712 having a flat shape as a whole between the pair of curved portions 711. It can also be said that the pair of curved portions 711 is disposed at positions that sandwich the flat portion 712 in the Z-axis direction.

Curved portions 711 are each formed of a portion having a curved shape that is curved in a semicircular arc shape so as to protrude in the Z-axis direction as viewed in the X-axis direction and extend in the X-axis direction. One curved portion 711 is disposed so as to face the bottom wall portion of the container body 160 and the other curved portion 711 is disposed so as to face the top wall portion of the lid body 170. That is, the pair of curved portions 711 is portions that is curved so as to protrude from the flat portion 712 toward the bottom wall portion of the container body 160 and the top wall portion of the lid body 170 as viewed in the X-axis direction, that is, toward both sides of the flat portion 712 in the Z-axis direction.

The flat portions 712 are portions having a rectangular flat shape that connect the end portions of the pair of curved portions 711 to each other and extend parallel to the XZ plane directed in the Y-axis direction. The flat portions 712 are disposed so as to face the long side wall portions of the container body 160 on both sides in the Y axis direction. The flat portion 712 is a main portion of the electrode assembly 700. In the flat portion 712, a plurality of wound plates (the positive plate 740 and the negative plate 750) are stacked in the Y-axis direction. That is, in the flat portion 712, the Y-axis direction is a stacking direction of the plurality of plates. As described above, the flat portion 712 is a main portion of the electrode assembly 700 and hence, a main stacking direction of the electrode assembly 700 is defined as the Y-axis direction in the present disclosure.

The curved shape of the curved portion 711 is not limited to a semicircular arc shape, and may be a part of an elliptical shape or the like. That is, the curved portion 711 may be curved in any shape. The flat portion 712 is not limited to a shape where an outer surface of the flat portion 712 directed in the Y-axis direction is a flat surface, and the outer surface may be slightly recessed or may be slightly bulged.

### 3 Positional Relationship Between Terminal Body Portion, Recessed Portion, Electrode Assembly, and Current Collector

Next, the positional relationship between the terminal body portion 330, the recessed portion 101, the electrode assembly 700, and the current collector 600 will be described. In the present embodiment, the description is made by exemplifying the first side surface portion 110. However, the second side surface portion 120 has substantially the same configuration and hence, the description of the second side surface portion 120 is omitted.

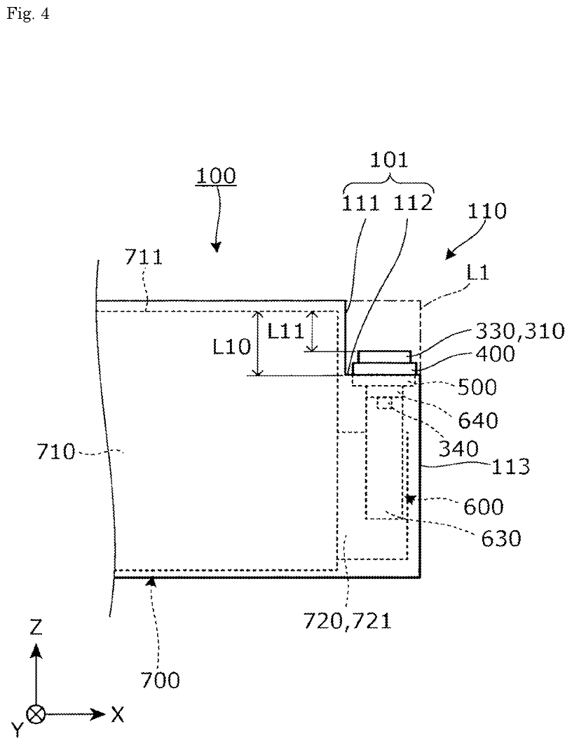

FIG. 4 is a plan view illustrating the first side surface portion 110 according to the embodiment. In FIG. 4, the internal structure of the container 100 is indicated by a broken line. Also in FIG. 4, a rectangular parallelepiped shape of the container 100 that is used as a reference is indicated by a double-dashed chain line L1. Accordingly, the “the inside of the recessed portion 101” means a region that is defined by a profile of a rectangular parallelepiped shape (double-dashed chain line L1) that is used as the reference, the first upper side surface 111, and the first upper surface 112.

As illustrated in FIG. 4, in the recessed portion 101, the terminal body portion 330 of the positive electrode terminal 310 is mounted on the first upper surface 112 that forms the terminal mounting surface in a protruding manner outward by way of the outer gasket 400. Specifically, the terminal body portion 330 protrudes from the first upper surface 112 in a direction (Z-axis direction) that intersects with the stacking direction (Y-axis direction) of the electrode assembly 700. In this state, the entirety of the terminal body portion 330 of the positive electrode terminal 310 is accommodated in the recessed portion 101 as viewed in the Y-axis direction. That is, the terminal body portion 330 of the positive electrode terminal 310 is disposed below the top surface 140 as a whole.

In the first side surface portion 110, the positive electrode connecting portion 721 of the electrode assembly 700 is disposed below the recessed portion 101. That is, when the first upper surface 112 that forms the terminal mounting surface is viewed in the plan view, the positive electrode connecting portion 721 is disposed in a space that overlaps with the first upper surface 112. With such a configuration, the positive electrode connecting portion 721 is disposed at a position where the positive electrode connecting portion 721 is retracted from the portion that forms the first upper side surface 111 and hence, the body portion 710 of the electrode assembly 700 can be disposed close to the portion that forms the first upper side surface 111. Accordingly, it is possible to form the body portion 710 that is a portion contributing to the storage of power (generation of power) as large as possible.

The current collector 600 extends in the Z-axis direction in a space that overlaps with the first upper surface 112 when the first upper surface 112 that forms the terminal mounting surface is viewed in the plan view. Specifically, a first joint portion 630 of the current collector 600 is a plate-like portion that extends in the Z-axis direction, and is joined to the positive electrode connecting portion 721. The second joint portion 640 of the current collector 600 is a plate-like portion that is bent from an upper end of the first joint portion 630, and is joined to the shaft portion 340 of the positive electrode terminal 310. The first joint portion 630 and the second joint portion 640 are accommodated in a space that overlaps with the first upper surface 112 when the first upper surface 112 is viewed in the plan view. That is, the first joint portion 630 and the positive electrode tab portion 721 are joined to each other in the space in a state where the current collector 600 does not protrude from the space, and the joining structure of these constitutional elements also does not protrude from the space.

An upper end portion (the curved portion 711 in the Z-axis positive direction) of the body portion 710 of the electrode assembly 700 is disposed above the first upper surface 112. More specifically, the upper end portion of the body portion 710 is disposed above the terminal body portion 330. In other words, a distal end portion of the body portion 710 in the protruding direction of the terminal body portion 330 (the curved portion 711 in the Z-axis positive direction) protrudes more than the distal end portion of the terminal body portion 330. That is, as illustrated in FIG. 4, the distal end portion of the body portion 710 protrudes from the terminal body portion 330 by a length L10. Further, it may be also expressed that the distal end portion of the body portion 710 protrudes from the distal end surface of the positive electrode terminal 310 by a length L11 (<L10).

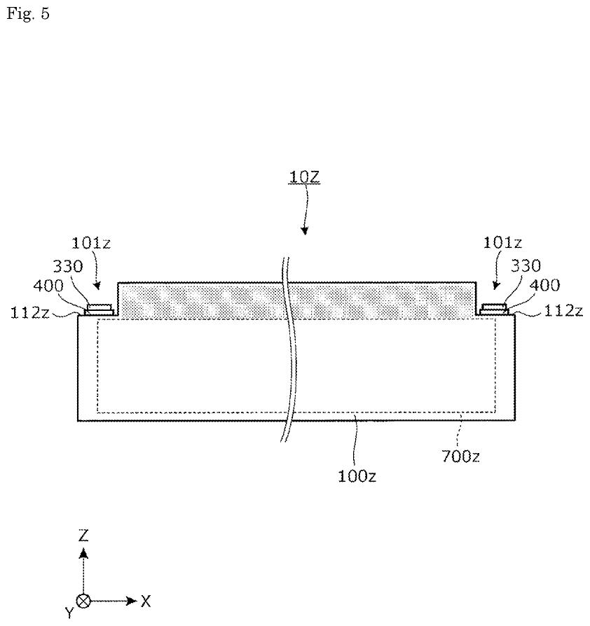

FIG. 5 is a plan view schematically illustrating an energy storage device 10Z according to a comparative example. In the energy storage device 10Z illustrated in FIG. 5, an upper end portion of the electrode assembly 700z is disposed below a first upper surface 112z that forms a terminal mounting surface. Therefore, in a container 100z, a space between a pair of recessed portions 101z forms a surplus space (a portion indicated by dotted hatching in FIG. 5).

On the other hand, in the present embodiment, the upper end portion of the body portion 710 of the electrode assembly 700 is disposed above the terminal body portion 330 and hence, the body portion 710 can be disposed in the surplus space described above. As a result, the surplus space in the container 100 is reduced.

### 4 Description of Advantageous Effects

As has been described above, in the energy storage device 10 according to the embodiment of the present invention, the distal end portion of the body portion 710 of the electrode assembly 700 protrudes with respect to the first upper surfaces 112 (terminal mounting surfaces) of the container 100 and hence, the body portion 710 can be disposed in the surplus space formed between the terminal body portions 330 of the pair of electrode terminals 300. With such a configuration, the surplus space in the container 100 can be reduced. Accordingly, it is possible to suppress the lowering of the space utilization efficiency of the energy storage device 10. As a result, the electric capacitance of the energy storage device 10 can be also increased. In the present embodiment, the space utilization efficiency means the degree of effective use of the space in the energy storage device 10, it may be expressed that, when the surplus space is large, the degree of effective use is low and hence, the space utilization efficiency is also lowered.

Even in a case where the distal end portion of the body portion 710 is coplanar with the first upper surfaces 112 (terminal mounting surfaces) of the container 100, the distal end portion of the body portion 710 is disposed in the surplus space and hence, it is possible to suppress the lowering of the space utilization efficiency of the energy storage device 10 to some extent. In such a configuration, the term “coplanar” also includes a state where a top point of the curved portion 711 in the Z-axis positive direction that is the distal end portion of the body portion 710 and the first upper surfaces 112 that are the terminal mounting surfaces are at the same height position.

To the contrary, in the present embodiment, the distal end portion of the body portion 710 of the electrode assembly 700 protrudes more than the distal end portions of the terminal body portions 330. Accordingly, the body portion 710 can be disposed with a larger size in the surplus space formed between the terminal body portions 330 of the pair of electrode terminals 300. With such a configuration, it is possible to further suppress the lowering of the space utilization efficiency of the energy storage device 10 and hence, it is also possible to further increase the electric capacitance of the energy storage device 10.

A first joint portion 630a of the current collector 600 and a second joint portion 640a of the current collector 600 are accommodated in a space that overlaps with the first upper surface 112 when the first upper surface 112 is viewed in a plan view. That is, the first joint portion 630 and the positive electrode connecting portion 721 are joined to each other in the space in a state where the current collector 600 does not protrude from the space, and the joining structure of these constitutional elements also does not protrude from the space. With such a configuration, even when the body portion 710 of the electrode assembly 700 is disposed as large as possible, the current collector 600 and the positive electrode connecting portion 721 can be easily joined to each other.

Each of the positive electrode connecting portion 721 and the negative electrode connecting portion 722 is disposed in a space that overlaps with the terminal mounting surfaces (the first upper surface 112, the second upper surface 122) when the terminal mounting surfaces are viewed in the plan view. Accordingly, the body portion 710 of the electrode assembly 700 can be formed as large as possible between the pair of terminal mounting surfaces of the container 100. The body portion 710 of the electrode assembly 700 is a portion that contributes to the storage of energy (generation of power) and hence, the electric capacitance can be increased by forming the portion largely.

### 5 Description of Modifications

Next, respective modifications of the above-mentioned embodiment will be described. In the following description, components equivalent to the components in the above-mentioned embodiment or other modifications are denoted by the same reference numerals, and the description of these components may be omitted. In the following description, the first side surface portion will be described as an example. However, the second side surface portion also has substantially the same shape as the first side surface portion.

### Modification 1

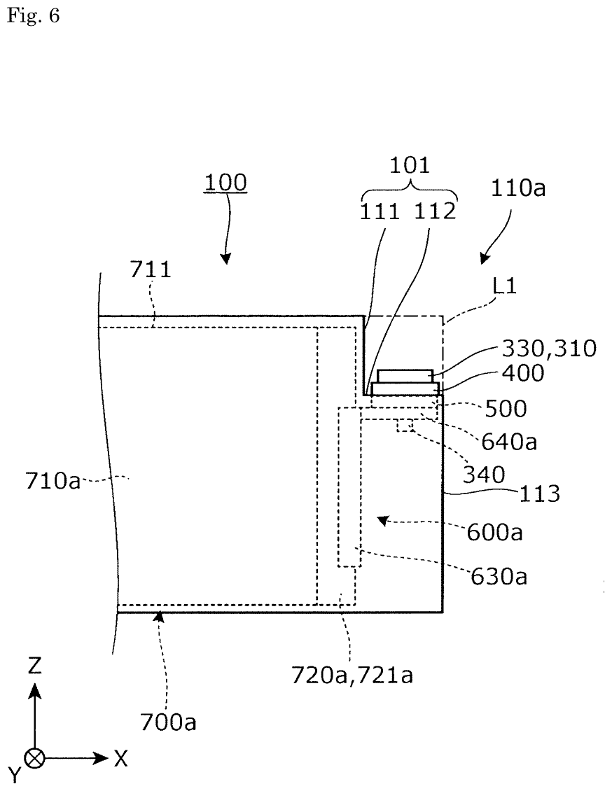

Next, a modification 1 of the embodiment described above will be described. FIG. 6 is a plan view illustrating a first side surface portion 110a according the modification 1 of the embodiment. In the embodiment described above, the electrode assembly 700 is exemplified where the connecting portion 720 is formed on a part of the body portion 710 in the Z-axis direction. In the modification 1, the description is made by exemplifying an electrode assembly 700a where a connecting portion 720a is disposed over the entirety of a body portion 710a in the Z-axis direction.

Specifically, as illustrated in FIG. 6, in the electrode assembly 700a, a positive electrode connecting portion 721a protrudes in the X-axis positive direction from the entirety of the electrode assembly body 710a in the Z-axis direction. Accordingly, the body portion 710a is disposed so as to be positioned more in the X-axis negative direction than a recessed portion 101.

A first joint portion 630a of a current collector 600a is joined to the positive electrode connecting portion 721a. A second joint portion 640a of the current collector 600a is bent from an upper end of the first joint portion 630a in a direction (an X-axis positive direction) away from the body portion 710, and is joined to a shaft portion 340 of a positive electrode terminal 310. As described above, the second joint portion 640 of the current collector 600 is bent with respect to the first joint portion 630 in a direction away from the body portion 710 and hence, the second joint portion 640 can be easily joined to the electrode terminal 300 disposed more outside than the body portion 710.

### Modification 2

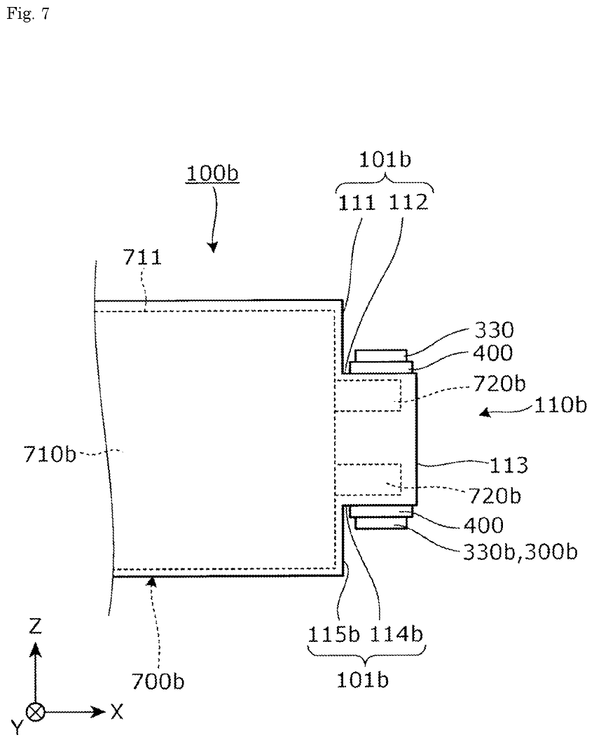

Next, a modification 2 of the embodiment described above will be described. FIG. 7 is a plan view illustrating a first side surface portion 110b according to the modification 2 of the embodiment. In the embodiment described above, the case is exemplified where one recessed portion 101 is formed on the first side surface portion 110. In the modification 2, the description is made by exemplifying a container 100b where two recessed portions 101b are formed on the first side surface portion 110b.

As illustrated in FIG. 7, a pair of recessed portions 101b is formed on each of both end portions of the first side surface portion 110b in the Z axis direction. The recessed portion 101b in the X-axis negative direction is defined by a first lower surface 114b that is a cutout formed on the first side surface portion 110b and a first lower side surface 115b. A terminal body portion 330b of an electrode terminal 300b is mounted on the first lower surface 114b that forms a terminal mounting surface.

In the modification 2, an electrode assembly 700b has a pair of tab-shaped connecting portions 720b at each of both end portions thereof in the X axis direction. The pair of connecting portions 720b is arranged in the Z-axis direction. The connecting portion 720b in the Z-axis positive direction is connected to the electrode terminal 300 disposed in the recessed portion 101b in the Z-axis positive direction via a current collector (not illustrated in the drawing). The connecting portion 720b in the Z-axis negative direction is connected to the electrode terminal 300b disposed in the recessed portion 101b in the Z-axis negative direction via a current collector (not illustrated in the drawing). In this case, a lower end portion of a body portion 710b of the electrode assembly 700b is disposed below the terminal mounting surface (first lower surface 114b) of the recessed portion 101b. Accordingly, the body portion 710b can be disposed in a surplus space disposed in a lower portion of the container 100b. The electrode terminal may not be disposed in the recessed portion 101b.

### Modification 3

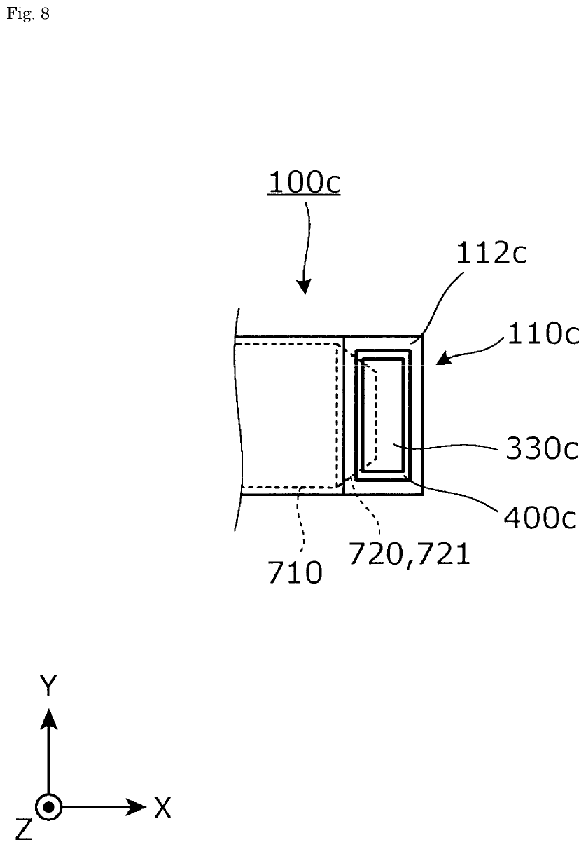

Next, a modification 3 of the embodiment described above will be described. FIG. 8 is a top plan view illustrating a first side surface portion 110c according to the modification 3 of the embodiment. In the embodiment described above, the case is exemplified where the first upper surface 112 is elongated in the X-axis direction (predetermined direction). In the modification 2, a case is exemplified where a first upper surface 112c is elongated in the Y-axis direction (the stacking direction).

As illustrated in FIG. 8, the first upper surface 112c is formed in a rectangular shape where a length in the Y-axis direction is longer than a length in the X-axis direction. An outer gasket 400c and a terminal body portion 330c are shaped so as to be accommodated in the first upper surface 112c. Specifically, both the outer gasket 400c and the terminal body portion 330c are formed in a rectangular shape where a length in the Y-axis direction is longer than a length in the X-axis direction.

A case is considered where an electrode assembly 700 has the structure where an upper end portion of a body portion 710 is coplanar with the first upper surface 112c (terminal mounting surface) or protrudes from the first upper surface 112c (terminal mounting surface). In this case, it is necessary to position the terminal mounting surface more in the X-axis positive direction than the body portion 710. In this case, there is also a demand that a size of the terminal mounting surface should be made as small as possible in order to suppress the large-sizing of a container 100c. To satisfy such a demand, as described above, by forming the first upper surface 112c, that is, the terminal mounting surface in a shape where the length in the Y-axis direction (stacking direction) is longer than the length in the X-axis direction (predetermined direction), the size of the terminal body portion 330c can be made as large as possible within the terminal mounting surface. With such a configuration, a joint area between the conductive member such as a bus bar and a terminal body portion 330c can be made as large as possible.

### Other Modifications

Although the energy storage device according to the embodiment of the present invention (including the modifications of the embodiment, the same understanding being adopted in the description made hereinafter) has been described heretofore, the present invention is not limited to the embodiment and modifications described above. That is, the embodiment disclosed this time is illustrative in all aspects, and is not limitative. The present invention includes all alterations which fall within the scope of claims or are considered equivalent to the present invention called for in claims.

For example, in the embodiment described above, the case where only one electrode assembly 700 is accommodated in the container 100 has been exemplified. However, a plurality of electrode assemblies may be accommodated in the container.

In the above-mentioned embodiment, the winding-type electrode assembly 700 is exemplified as an example of the electrode assembly formed by laminating a plurality of plates. However, besides the above-mentioned winding-type electrode, the electrode assembly where the plurality of plates are stacked includes: a stacking type electrode assembly where flat plate-shaped electrode plates are stacked; and an electrode assembly where plates and/or separators are folded in a bellows shape (a mode where the separator is folded in a bellows shape so as to sandwich plates having a rectangular shape, a mode where the plates and the separators are made to overlap with each other and, thereafter, these plates and the separators are folded in a bellows shape and the like). In all cases, it is sufficient that the stacking direction of the electrode assembly be set to the Y-axis direction. For example, even in the case of a non-winding-type electrode assembly such as a stacking type electrode assembly, a profile of the electrode assembly is formed in a shape that corresponds to the profile of the electrode assembly 700 illustrated in FIG. 4. In this case, an upper end portion and the other end portion of the non-winding type electrode assembly have a planar shape.

In the embodiment described above, the case is exemplified where the recessed portion 101 is disposed at the same position in the first side surface portion 110 and the second side surface portion 120. However, the recessed portion 101 may be disposed at different positions between the first side surface portion 110 and the second side surface portion 120.

In the embodiment described above, the case is exemplified where the recessed portion 101 is formed on the end portion of each of the first side surface portion 110 and the second side surface portion 120 in the Z axis positive direction. However, in each of the first side surface portion 110 and the second side surface portion 120, a recessed portion may also be formed at an end portion in the Z-axis negative direction. In this case, one surface on which the recessed portion in the Z-axis negative direction is formed may be used as the terminal mounting surface. For example, in a case where a lower surface of the container that forms a recessed portion in the Z-axis negative direction is set as a terminal mounting surface, a lower end portion of a body portion of an electrode assembly is formed in a protruding manner from the terminal mounting surface or in a coplanar manner with the terminal mounting surface. Accordingly, a surplus space formed in a lower portion of the inside of a container can be reduced.

The configurations that are formed by arbitrarily combining the respective constituent elements that the embodiments and the modification examples described above include also fall within the scope of the present invention.

### INDUSTRIAL APPLICABILITY

The present invention is applicable to an energy storage device such as a lithium ion secondary battery or the like.

### DESCRIPTION OF REFERENCE SIGNS

10, 10Z: energy storage device
100, 100b, 100c, 100z: container
101, 101b, 101z: recessed portion
110, 110a, 110b, 110c: first side surface portion
111: first upper side surface
112, 112c, 112z: first upper surface (terminal mounting surface)
113: first side surface
114b: first lower surface
115b: first lower side surface
120: second side surface portion
121: second upper side surface
122: second upper surface (terminal mounting surface)
123: second side surface
130: long side surface
140: top surface
150: bottom surface
160: container body
170: lid body
300, 300b: electrode terminal (terminal)
330, 330b, 330c: terminal body portion
340: shaft portion
600, 600a: current collector
630, 630a: first joint portion
640, 640a: second joint portion
700, 700a, 700b, 700z: electrode assembly
710, 710a, 710b: body portion (electrode assembly body)
720, 720a, 720b: connecting portion
740: positive plate (plate)
750: negative plate

1. An energy storage device, comprising:
an electrode assembly comprising a plurality of plates stacked in stacking direction;
a container configured to accommodate the electrode assembly; and
a terminal is configured to be electrically connected to the electrode assembly,
wherein the electrode assembly is elongated in a predetermined direction intersecting with the stacking direction and includes an electrode assembly body and a connecting portion protruding from an end portion of the electrode assembly body in the predetermined direction, the terminal includes a terminal body portion protruding from a terminal mounting surface of the container in a direction intersecting with the stacking direction, and a distal end portion of the electrode assembly body in a protruding direction of the terminal body portion protrudes with respect to the terminal mounting surface.

2. The energy storage device according to claim 1, wherein the distal end portion of the electrode assembly body protrudes more than a distal end portion of the terminal body portion.

3. The energy storage device according to claim 1, further comprising:
a current collector accommodated in the container such that the current collector electrically connects the connecting portion and the terminal,
wherein the current collector extends in a direction intersecting with a protruding direction of the connecting portion in a space that overlaps with the terminal mounting surface.

4. The energy storage device according to claim 1, further comprising:
a current collector accommodated in the container such that the current collector electrically connects the connecting portion and the terminal,
wherein the current collector includes a first joint portion joined to the connecting portion and a second joint portion joined to the terminal, and the second joint portion is bent in a direction away from the electrode assembly body with respect to the first joint portion.

5. The energy storage device according to claim 1, wherein the terminal is formed such that a length of the terminal body portion in the stacking direction is longer than a length of the terminal body portion in the predetermined direction.

6. The energy storage device according to claim 1, wherein the connecting portion in the electrode assembly is disposed in a space that overlaps with the terminal mounting surface in the container.

7. The energy storage device according to claim 2, further comprising:
a current collector accommodated in the container such that the current collector electrically connects the connecting portion and the terminal,
wherein the current collector extends in a direction intersecting with a protruding direction of the connecting portion in a space that overlaps with the terminal mounting surface.

8. The energy storage device according to claim 2, further comprising:
a current collector accommodated in the container such that the current collector electrically connects the connecting portion and the terminal,
wherein the current collector includes a first joint portion joined to the connecting portion and a second joint portion joined to the terminal, and the second joint portion is bent in a direction away from the electrode assembly body with respect to the first joint portion.

9. The energy storage device according to claim 2, wherein the terminal is formed such that a length of the terminal body portion in the stacking direction is longer than a length of the terminal body portion in the predetermined direction.

10. The energy storage device according to claim 2, wherein the connecting portion in the electrode assembly is disposed in a space that overlaps with the terminal mounting surface in the container.

11. The energy storage device according to claim 3, wherein the terminal is formed such that a length of the terminal body portion in the stacking direction is longer than a length of the terminal body portion in the predetermined direction.

12. The energy storage device according to claim 3, wherein the connecting portion in the electrode assembly is disposed in a space that overlaps with the terminal mounting surface in the container.

13. The energy storage device according to claim 4, wherein the terminal is formed such that a length of the terminal body portion in the stacking direction is longer than a length of the terminal body portion in the predetermined direction.

14. The energy storage device according to claim 4, wherein the connecting portion in the electrode assembly is disposed in a space that overlaps with the terminal mounting surface in the container.

15. The energy storage device according to claim 11, wherein the connecting portion in the electrode assembly is disposed in a space that overlaps with the terminal mounting surface in the container.

16. The energy storage device according to claim 13, wherein the connecting portion in the electrode assembly is disposed in a space that overlaps with the terminal mounting surface in the container.
